(19) United States
(12) Patent Application Publication
(10) Pub. No.: US 2012/0055424 A1
(43) Pub. Date: Mar. 8, 2012

(54) CYLINDER HEAD WITH TURBINE

(75) Inventor: Kai Sebastian Kuhlbach, Bergisch Gladbach (DE)

(73) Assignee: FORD GLOBAL TECHNOLOGIES, LLC, Dearborn, MI (US)

(21) Appl. No.: 13/226,267

(22) Filed: Sep. 6, 2011

(30) Foreign Application Priority Data
Sep. 7, 2010 (DE) 102010037378.8

(51) Int. Cl. F01P 1/06; F02B 33/44; F01D 1/04

(52) U.S. Cl. 123/41.31; 415/78; 60/605.3; 415/1

(57) ABSTRACT

The disclosure relates to a cylinder head having at least one cylinder. The cylinder head comprises a radial turbine including a rotor arranged in a turbine casing and rotatably mounted on a shaft, an overall exhaust line which opens into an inlet zone of the radial turbine, said zone merging into a flow duct which carries exhaust gas, and at least one coolant duct integrated into the turbine casing to form a cooling system, the at least one coolant duct extending in a spiral around the shaft in the casing, wherein the at least one coolant duct extends circumferentially around and at a distance from the flow duct over an angle α, where α≦45°.

### RELATED APPLICATIONS

This application claims priority to German Patent Application No. 102010037378.8, filed on Sep. 7, 2010, the entire contents of which being incorporated herein by reference.

### FIELD

The present disclosure relates to a cylinder head with a radial turbine.

### BACKGROUND AND SUMMARY

Internal combustion engines have a cylinder block and a cylinder head, which are connected to one another at the assembly faces thereof to form the at least one cylinder, i.e. combustion chamber. The cylinder block includes cylinder bores to hold the pistons. The cylinder head generally serves to accommodate the valve gear. The valve gear includes the intake and exhaust valves as well as the valve actuating mechanism required to move the valves.

Typically, the inlet ducts, which lead to the inlet ports, and the outlet ducts, i.e. the exhaust lines, which are connected to the outlet ports, are at least partially integrated into the cylinder head. The exhaust lines of the outlet ports of each individual cylinder are generally brought together—within the cylinder head—to form a component exhaust line. The exhaust lines are combined into an overall exhaust line referred to generally and in the context of the present disclosure as an exhaust manifold. Downstream of the at least one manifold, the exhaust gases are then fed to a radial turbine, e.g. the turbine of an exhaust turbocharger and, if appropriate, are passed through one or more exhaust gas aftertreatment systems.

The production costs for the turbine are comparatively high since the material—which frequently contains nickel—used for the thermally highly stressed turbine casing is expensive, especially in comparison with the material that is preferably used for the cylinder head; e.g. aluminum.

It would be advantageous in terms of costs if it were possible to provide a turbine which could be manufactured from a less expensive material, e.g. aluminum. To enable less expensive materials to be used to produce the turbine, turbines may be provided with a cooling system, e.g. a liquid cooling system, which greatly reduces the thermal stress imposed by the hot exhaust gases on the turbine and on the turbine casing and hence allows the use of materials less capable of bearing thermal stresses.

In general, the turbine casing is provided with a coolant jacket in order to form the cooling system. This includes both concepts in which the casing is a casting and the coolant jacket is formed as an integral part of a monolithic casing as part of the casting process, and concepts in which the casing is of modular construction, where a cavity which serves as a coolant jacket is formed during assembly.

A turbine configured in accordance with the last-mentioned concept is described by German Laid-Open Application DE 10 2008 011 257 A1, for example. A liquid cooling system for the turbine is formed by providing the actual turbine casing with a shell, thus forming a cavity, into which coolant can be passed, between the casing and the at least one shell element arranged at a distance. The casing with the shell added then includes the coolant jacket. EP 1 384 857 A2 likewise discloses a turbine, the casing of which is provided with a coolant jacket. DE 10 2007 017 973 A1 describes a kit for the formation of a vapor-cooled turbine jacket.

In principle, there is the possibility of providing the liquid cooling system of the turbine with a separate heat exchanger or the heat exchanger of another liquid cooling system. However, one factor that has to be taken into account in this context is that the amount of heat to be absorbed by the coolant in the turbine can be 40 kW or more if materials with little resistance to thermal stress, such as aluminum, are used for the production of the casing. Removing such a large amount of heat from the coolant in the heat exchanger and dissipating it to the environment by means of an air flow proves to be problematic, as surface area available for heat transfer may be limited.

In addition to the heat exchanger of the engine cooling system, modern motor vehicles often have additional heat exchangers, in particular cooling devices. For example, charge air coolers, oil coolers, EGR coolers, transmission fluid coolers, air conditioning condenser, etc., may all be arranged in or near the front end zone. Thus, owing to the very restricted space conditions in the front end zone and the large number of heat exchangers, it may not be possible to dimension the individual heat exchangers as required. Also, there may be no possibility of arranging a sufficiently large heat exchanger for liquid cooling of the turbine in the front end zone to allow dissipation of the large amounts of heat. There has therefore to be a compromise between cooling capacity and material in the design configuration of a cooled turbine.

The inventors herein have recognized the above issues and have developed a solution to at least partly address them. Accordingly, a cylinder head is disclosed. The cylinder head comprises a radial turbine comprising a rotor arranged in a turbine casing and rotatably mounted on a shaft, an overall exhaust line which opens into an inlet zone of the radial turbine, said zone merging into a flow duct which carries exhaust gas, and at least one coolant duct integrated into the turbine casing to form a cooling system, the at least one coolant duct extending in a spiral around the shaft in the casing, wherein the at least one coolant duct extends circumferentially around and at a distance from the flow duct over an angle α, where α≦45°.

In this way, the coolant duct provided in the casing does not completely envelop, i.e. encase the rotor, like a coolant jacket but covers the flow duct only over a limited angular range cc in the circumferential direction, where α≦45°.

In another embodiment, a method for cooling a turbine is provided. The method comprises routing coolant through at least one coolant jacket arranged in an exhaust passage side of a cylinder head to a coolant duct of the turbine, the coolant duct of the turbine extending circumferentially around and at a distance from a flow duct of the turbine only over an angle α, where α≦45°.

The aim here is not to achieve jacketing of the rotor over as large an area as possible and thus ensure the greatest possible heat dissipation. On the contrary, cooling capacity is deliberately limited by dimensioning the at least one coolant duct in the manner according to the present disclosure. Cooling capacity is restricted by the limited heat transfer surface provided.

Thus, the maximum amount of heat that can be dissipated is advantageously reduced or limited. This eliminates the problem of having to dissipate very large amounts of heat absorbed by the coolant in the turbine. In accordance with the moderate cooling capacity, an appropriate material may be chosen for the production of the turbine according to the disclosure, namely grey cast iron or cast steel.

The present disclosure may provide several advantages. For example, it makes it possible to dispense with materials with the capacity to bear high thermal stresses, especially those containing nickel, for the production of the turbine casing, since the present description also makes provision for the turbine to be provided with a cooling system. The cooling system ensures a reduction in temperature and hence reduces the thermal stress on the material, rendering materials resistant to high temperatures unnecessary. On the other hand, the cooling capacity chosen is not so large that materials with only little resistance to thermal stress, such as aluminum, can be employed. This approach makes the use of expensive materials unnecessary without dissipating excessively large amounts of heat in the context of turbine cooling.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows a cylinder of an internal combustion engine according to an embodiment of the present disclosure.

FIG. 2 schematically shows multiple cylinders of the internal combustion engine of FIG. 1.

FIG. 3 shows a first embodiment of the turbine in a section perpendicular to the shaft of the turbine rotor.

FIG. 4 shows the section A-A indicated in FIG. 3.

FIG. 5 shows the section B-B indicated in FIG. 3.

### DETAILED DESCRIPTION

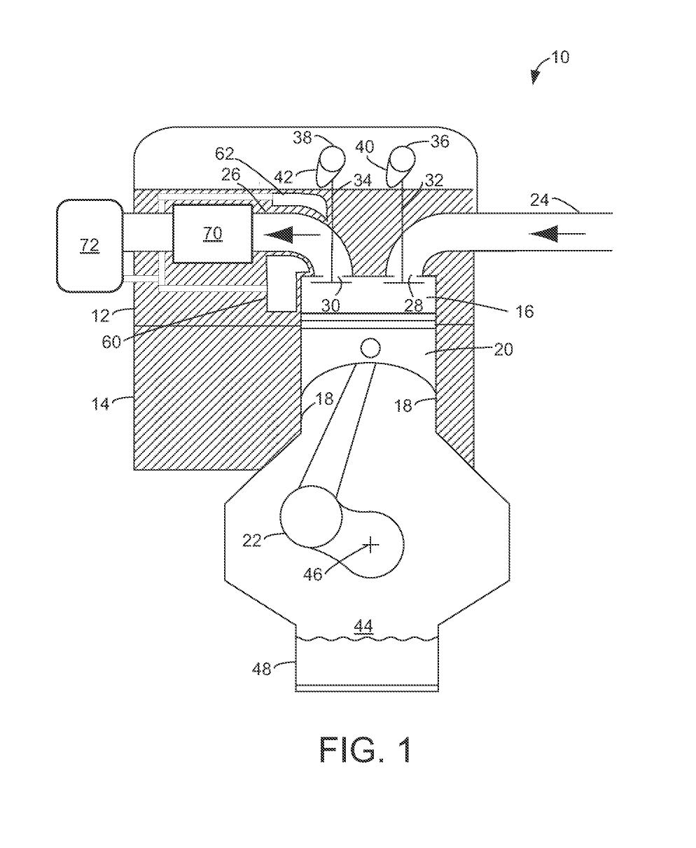

FIG. 1 is a schematic diagram showing one cylinder 16 of a multi-cylinder engine 10, which may be included in a propulsion system of an automobile. The engine 10 includes a cylinder head 12 and a cylinder block 14 which are connected to one another at their assembly end sides so as to form a combustion chamber.

Combustion chamber (i.e. cylinder) 16 of engine 10 may include combustion chamber walls 18 with piston 20 positioned therein. Piston 20 may be coupled to crankshaft 22 so that reciprocating motion of the piston is translated into rotational motion of the crankshaft. Crankshaft 22 may be coupled to at least one drive wheel of a vehicle via an intermediate transmission system. Further, a starter motor may be coupled to crankshaft 22 via a flywheel to enable a starting operation of engine 10.

Combustion chamber 16 may receive intake air from an intake manifold (not shown) via intake line, or intake passage, 24 and may exhaust combustion gases via exhaust line, or exhaust passage, 26. Exhaust passage 26 may be coupled to an exhaust manifold 70, which in the depicted embodiment is integrated into cylinder head 12. Intake passage 24 and exhaust passage 26 can selectively communicate with combustion chamber 16 via inlet opening 28 and outlet opening 30 and respective intake valve 32 and exhaust valve 34. In some examples, combustion chamber 16 may include two or more intake valves and/or two or more exhaust valves.

During operation, each cylinder within engine 10 typically undergoes a four stroke cycle: the cycle includes the intake stroke, compression stroke, expansion stroke, and exhaust stroke. During the intake stroke, generally, the exhaust valve 34 closes and intake valve 32 opens. Air is introduced into combustion chamber 16 via intake passage 24, and piston 20 moves to the bottom of the cylinder so as to increase the volume within combustion chamber 16. The position at which piston 20 is near the bottom of the cylinder and at the end of its stroke (e.g. when combustion chamber 16 is at its largest volume) is typically referred to by those of skill in the art as bottom dead center (BDC). During the compression stroke, intake valve 32 and exhaust valve 34 are closed. Piston 20 moves toward the cylinder head so as to compress the air within combustion chamber 16. The point at which piston 20 is at the end of its stroke and closest to the cylinder head (e.g. when combustion chamber 16 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as a spark plug (not shown), resulting in combustion. During the expansion stroke, the expanding gases push piston 20 back to BDC. Crankshaft 22 converts piston movement into a rotational torque of the rotary shaft. Finally, during the exhaust stroke, the exhaust valve 34 opens to release the combusted air-fuel mixture to exhaust passage 26 and the piston returns to TDC. Note that the above is shown merely as an example, and that intake and exhaust valve opening and/or closing timings may vary, such as to provide positive or negative valve overlap, late intake valve closing, or various other examples.

A valve actuating device depicted in FIG. 1 comprises two camshafts 36 and 38, on which a multiplicity of cams 40, 42 are arranged. A basic distinction is made between an underlying camshaft and an overhead camshaft. This relates to the parting plane, that is to say assembly surface, between the cylinder head and cylinder block. If the camshaft is arranged above said assembly surface, it is an overhead camshaft, otherwise it is an underlying camshaft. Overhead camshafts are preferably mounted in the cylinder head, and are depicted in FIG. 1.

The cylinder head 12 is connected, at an assembly end side, to a cylinder block 14 which serves as an upper half of a crankcase 44 for holding the crankshaft 22 in at least two bearings, one of which is depicted as crankshaft bearing 46. At the side facing away from the cylinder head 12, the cylinder block 14 is connected to an oil pan 48 which serves as a lower crankcase half and which is provided for collecting and storing engine oil.

The heat released during combustion by the exothermic chemical conversion of the fuel is dissipated in part to the cylinder head 12 and the cylinder block 14 via the walls bounding the combustion chamber 16 and in part to the adjoining components and the environment via the exhaust gas flow. To reduce the thermal stress on the cylinder head 12, some of the heat flow introduced into the cylinder head 12 may be removed from the cylinder head 12 again.

Owing to the significantly higher heat capacity of liquids relative to air, significantly larger amounts of heat can be dissipated by a liquid cooling system than with an air cooling system, for which reason cylinder heads of the type in question are advantageously provided with a liquid cooling system.

Liquid cooling requires that the cylinder head be provided with at least one coolant jacket, i.e. the arrangement of coolant ducts which carry the coolant through the cylinder head, and this requires a cylinder head design with a complex structure. On the one hand, this means that the mechanically and thermally highly stressed cylinder head is weakened by the introduction of the coolant ducts. On the other hand, the heat does not first have to be conducted to the surface of the cylinder head in order to be dissipated, as with the liquid cooling system. The heat is released to the coolant, generally water containing additives, within the cylinder head itself. In this arrangement, the coolant is delivered by a pump arranged in the cooling circuit and thus circulates in the coolant jacket. In this way, the heat released to the coolant is dissipated from the interior of the cylinder head and removed from the coolant again in a heat exchanger.

The cooling capacity may be sufficiently high to eliminate or reduce enrichment (λ<1) in order to lower the temperature of the exhaust gas, as described in EP 1 722 090 A2, for example, which is regarded as disadvantageous from the point of view of energy considerations—especially as regards the fuel consumption of the internal combustion engine—and as regards pollutant emissions. This is because enrichment involves the injection of more fuel than can possibly be burnt with the quantity of air provided, with the additional fuel likewise being heated and vaporized, thus lowering the temperature of the combustion gases. In particular, the required enrichment does not always allow the internal combustion engine to be operated in the manner that would, for example, be optimal for an exhaust gas aftertreatment system provided. That is to say this results in limitations in the operation of the internal combustion engine.

Thus, cylinder head 12 may include one or more coolant jackets 60, 62. As depicted in FIG. 1, lower coolant jacket 60 is located between exhaust passage 26 and the assembly end side of cylinder head 12, while upper coolant jacket 62 is located on the opposite side of exhaust passage 26 from coolant jacket 60. As shown, coolant jacket 60 is coupled coolant jacket 62 via a flow passage, which in turn is coupled to turbocharger turbine 72 in order to provide coolant flow to the turbocharger. Thus, coolant may be routed through at least one coolant jacket 60 arranged in an exhaust passage side of the cylinder head 12 to a coolant duct of the turbine 72, as will be described in more detail below. As shown in FIG. 1, turbine 72 is coupled to cylinder head 12 on an outside of the cylinder head 12. However, in some embodiments, turbine 72 may be integrated in cylinder head 12.

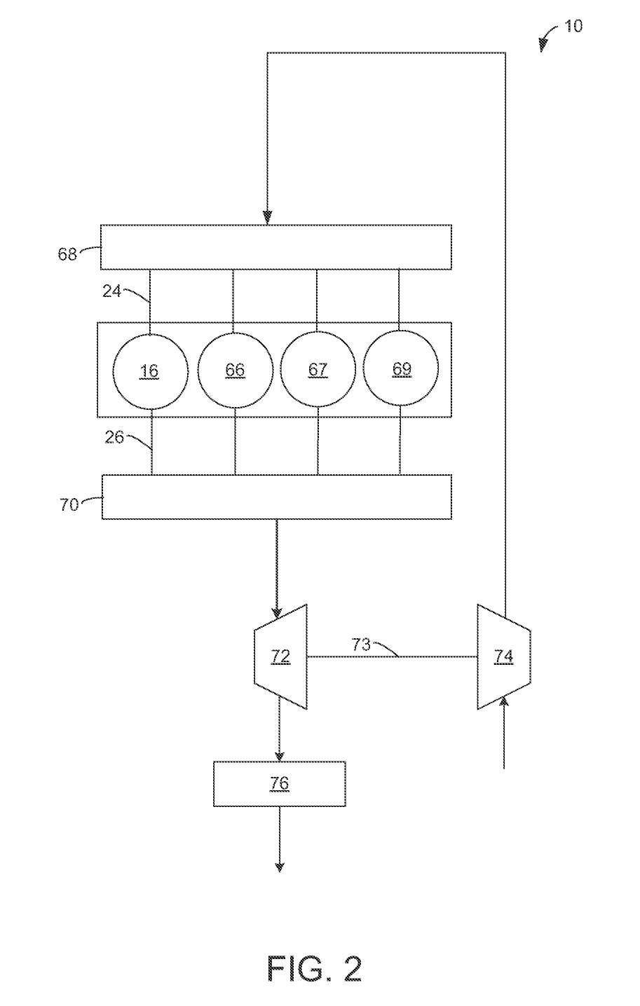

Turning to FIG. 2, the engine 10 described with reference to FIG. 1 is depicted. Here, multiple cylinders of engine 10 are shown. In addition to cylinder 16, cylinders 66, 67, and 69 are depicted. While engine 10 is here depicted as a four-cylinder engine, it is to be understood that any number of cylinders in any arrangement is within the scope of this disclosure.

An intake manifold 68 provides intake air to the cylinders via intake passages, such as intake passage 24. After combustion, exhaust gasses exit the cylinders via exhaust passages, such as exhaust passage 26, to the exhaust manifold 70. The exhaust lines of at least two cylinders may be merged to form an overall exhaust line within the cylinder head, so as to form an integrated exhaust manifold that permits the densest possible packaging of the drive unit. The exhaust gasses may pass through one or more aftertreatment devices 76 before exiting to the atmosphere.

The engine 10 may be supercharged by means of an exhaust-gas turbocharger. The exhaust gas may pass through a turbine 72 to drive a compressor 74 to provide boosted intake air to engine 10. The turbine may be coupled to the compressor by a shaft 73.

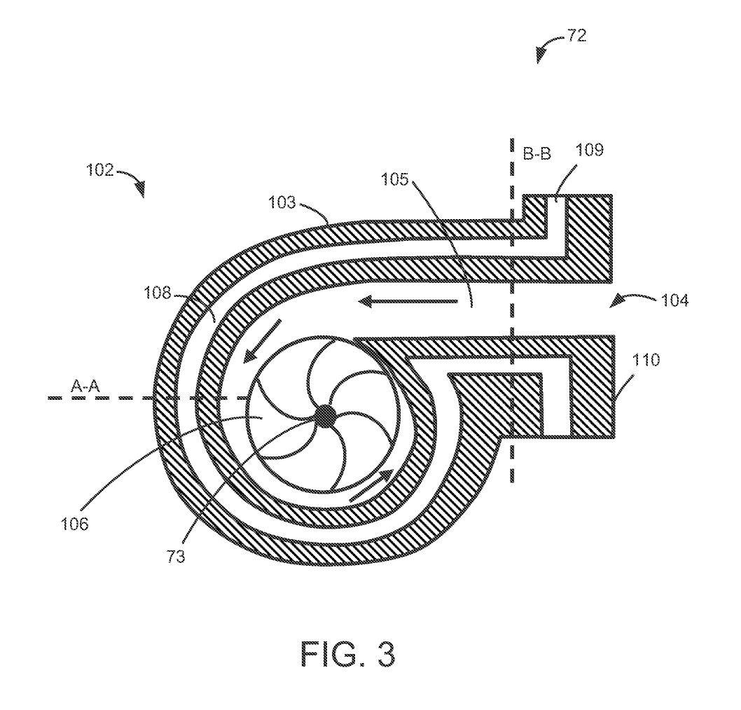

FIG. 3 shows a first embodiment of the turbine 72 in a section perpendicular to the shaft 73 of the turbine rotor 106. The turbine 72 is a radial turbine 102, which comprises a rotor 106 arranged in a turbine casing 103 and rotatably supported on a shaft 107. To allow radial inflow to the rotor blades, the inlet zone 104, which merges downstream into a flow duct 105, is of spiral design and the casing 103 for supplying the exhaust gas is designed as a spiral casing which extends all the way round the rotor 106.

To form a cooling system, the casing 103 has an integrated coolant duct 108, which extends in a spiral around the shaft 107 in the casing 103 and hence follows the flow duct 105 as far as the entry of the exhaust gas into the rotor 106. Provided adjacent to the inlet zone 104 of the turbine casing 103 are duct openings 109 to enable coolant to be introduced into and discharged again from the coolant duct 108. To enable the turbine 101 to be attached to the cylinder head (not shown in FIG. 3), the casing 103 is provided with a flange 110.

According to an embodiment of the present disclosure, the turbine 72 is embodied as a radial turbine 102, and thus the flow entering the rotor blades is substantially radial. In this context, substantially radial means that the velocity component in the radial direction is larger than the axial velocity component. The velocity vector of the flow intersects the shaft 73 or axis of the turbine 102, more particularly at a right angle, if the flow entering is exactly radial. To this extent, the radial turbine 102 can also be of mixed-flow construction as long as the velocity component in the radial direction is larger than the velocity component in the axial direction.

To enable the flow to enter the rotor blades radially, the inlet zone 104 for feeding in the exhaust gas is often designed as a spiral or volute casing that extends all the way round, ensuring that the inflow of exhaust gas to the turbine 102 is substantially radial.

The cylinder head according to the present disclosure with a radial turbine 102 is suitable especially for pressure-charged internal combustion engines, which are subject to particularly high thermal stresses owing to the relatively high exhaust gas temperatures. Consequently, cooling of the turbine of the exhaust gas turbocharger is advantageous. Thus, in the embodiment depicted, the radial turbine 102 is included in a turbocharger.

Pressure charging is used primarily to boost the power of the internal combustion engine. The air required for the combustion process is compressed, enabling a larger air mass to be fed to each cylinder per working cycle. As a result, it is possible to increase the fuel mass and hence the mean pressure.

Pressure charging is a suitable way of boosting the power of an internal combustion engine while keeping the displacement unchanged or of reducing the displacement for the same power. In each case, pressure charging leads to an increase in power per unit installation volume and a more favorable power-to-mass ratio. Given identical vehicle boundary conditions, it is thus possible to shift the load population toward higher loads, where specific fuel consumption is lower. Consequently, pressure charging assists the constant effort in the development of combustion engines to minimize fuel consumption, that is to say to improve the efficiency of internal combustion engines.

Compared with a mechanical charger, the advantage of an exhaust gas turbocharger is that there is no mechanical connection or no need for a mechanical connection to transmit power between the charger and the internal combustion engine. While a mechanical charger draws the energy required to drive it directly from the internal combustion engine, the exhaust gas turbocharger uses the energy of the hot exhaust gases.

As described above with respect to FIG. 2, the engine 10 including the turbocharger with the radial turbine according to the disclosure may include more than one cylinder. If the cylinder head has two cylinders and only the exhaust lines of one cylinder form an overall exhaust line which opens into the radial turbine, this is likewise a cylinder head according to the present disclosure.

If the cylinder head has three or more cylinders and only the exhaust lines of two cylinders combine to form an overall exhaust line, this is likewise a cylinder head according to the present disclosure.

Embodiments of the cylinder head in which, for example, the cylinder head has four cylinders arranged in series and the exhaust lines of the outer cylinders and the exhaust lines of the inner cylinders each combine to form an overall exhaust line are likewise cylinder heads according to the disclosure.

In the case of three and more cylinders, there is therefore also an advantage with embodiments in which at least three cylinders are configured in such a way that they form two groups, each comprising at least one cylinder, and the exhaust lines of the cylinders in each cylinder group in each case combine to form an overall exhaust line, thereby forming an exhaust manifold.

This embodiment is suitable especially for the use of a double-flow turbine. A double-flow turbine has an inlet zone with two inlet ducts, that is to say as it were two inlet zones, the two overall exhaust lines being connected to the double-flow turbine in such a way that one overall exhaust line opens into each inlet duct. Combination of the two exhaust flows carried in the overall exhaust lines may take place downstream of the turbine. If the exhaust lines are grouped in such a way that the high pressures, especially the exhaust lead pulses, can be preserved, a double-flow turbine is suitable especially for pulse charging, whereby it is possible to achieve high turbine pressure ratios at low rotational speeds.

However, grouping the cylinders and exhaust lines also offers advantages when using several turbines or exhaust gas turbochargers, with one overall exhaust line being connected to each turbine.

However, embodiments in which the exhaust lines of all the cylinders of the cylinder head are combined to form a single, or common, overall exhaust line are also advantageous, as depicted in FIG. 2.

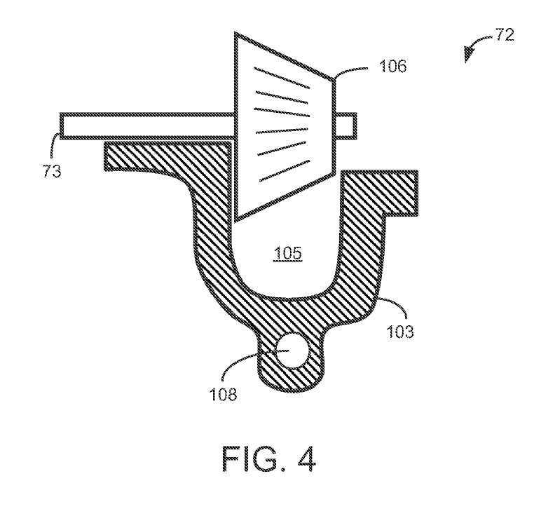

FIG. 4 shows the section A-A indicated in FIG. 3. The explanation is intended merely to supplement that for FIG. 3, and in other respects therefore reference is made to FIG. 3. Identical reference signs have been used for identical components.

In the section illustrated in FIG. 4, it can be seen that the coolant duct 108 extends at a distance from the flow duct 105, more specifically on that side of the flow duct 105 which is remote from the rotor 106. For integration or formation of the duct 105, the casing 103 has a protrusion in the form of a lug on the outside thereof.

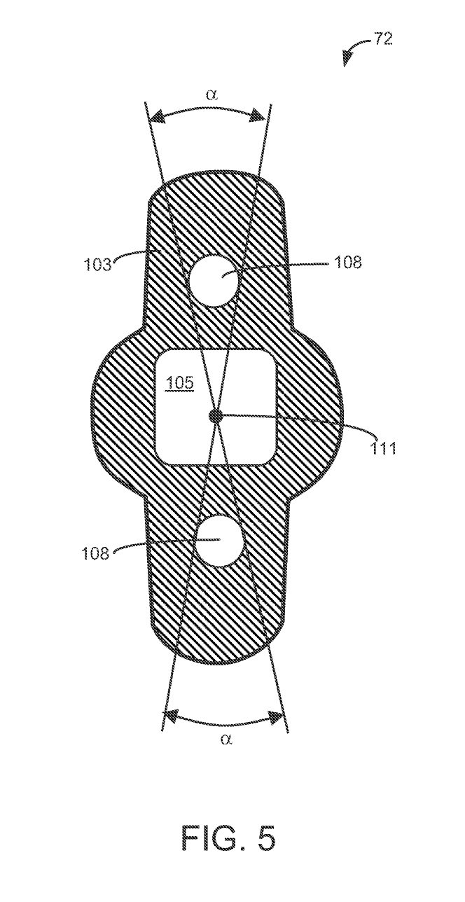

FIG. 5 shows the section B-B indicated in FIG. 3. The explanation is intended merely to supplement that for FIG. 3, and in other respects therefore reference is made to FIG. 3. Identical reference signs have been used for identical components.

In the embodiment illustrated in FIG. 5, the coolant duct 108 extends circumferentially around and at a distance from the flow duct 105 only over an angle α, where α≦45° and is measured from the center line 111 of the flow duct 105. As shown in FIG. 5, α≈30°. In the present case, therefore, the coolant duct does not extend over as large an area as possible around the flow duct 105, like a typical coolant jacket would. In this way, the amount of heat absorbed by the coolant is limited.

Additional embodiments may be advantageous. For example, embodiments in which the coolant duct extending in a spiral around the shaft in the casing meanders, or extends in snaking lines, are advantageous. Embodiments of the cylinder head in which the radial turbine has a coolant duct integrated into the casing to form a cooling system are advantageous. Embodiments of the cylinder head in which the turbine casing is a casting are advantageous. By casting and using appropriate cores, the complex structure of the casing can be formed in a single operation, with the result that finish machining of the casing and assembly are then required to form the turbine. Embodiments of the cylinder head in which each cylinder has two outlet ports for discharging the exhaust gases from the cylinder are advantageous.

Embodiments of the cylinder head in which α≦30°, advantageously α≦20° or α≦15°, are advantageous. The size of the angle chosen depends, in particular, on the material used for the casing. The smaller the angular range over which the coolant duct covers the flow duct in the circumferential direction, the smaller the casing volume required, and thus the smaller the amount of material used, this being decisively co-determined by the size of the coolant duct to be integrated. Consequently, the weight of the casing also increases or decreases with the size of the coolant duct.

It is the task of the valve gear to expose or close the inlet ports and outlet ports of the combustion chamber at the correct times, with rapid exposure of flow cross sections that are as large as possible being the aim in order to keep down throttling losses in the inflowing and outflowing streams of gas and to ensure optimum filling of the combustion chamber with fresh mixture and effective discharge of the exhaust gases. It is therefore advantageous to provide the cylinders with two or more inlet ports and/or outlet ports.

Embodiments of the cylinder head in which the exhaust lines are combined to form at least one overall exhaust line, thereby forming at least one integrated exhaust manifold within the cylinder head, are advantageous.

It should be taken into account that the fundamental aim is to arrange the turbine, in particular the turbine of an exhaust gas turbocharger, as close as possible to the outlet of the cylinders to enable optimum use to be made of the enthalpy of the hot exhaust gases and to ensure a rapid response from the turbine or turbocharger. The enthalpy of the hot exhaust gases depends decisively on the exhaust gas pressure and the exhaust gas temperature. Moreover, the path of the hot exhaust gases to the various exhaust gas aftertreatment systems should also be as short as possible, allowing the exhaust gases little time to cool and ensuring that the exhaust gas aftertreatment systems reach their operating temperature or light-off temperature as quickly as possible, especially after the internal combustion engine has been cold-started.

There is therefore a concern to minimize the thermal inertia of the section of the exhaust line between the outlet port at the cylinder and the turbine and between the outlet port at the cylinder and the exhaust gas aftertreatment system, this being achievable by reducing the mass and length of said section.

In order to achieve this aim, one previous approach to a solution combines the exhaust lines within the cylinder head to form at least one integrated exhaust manifold.

This reduces the length of the exhaust lines. On the one hand, the volume of the lines, i.e. the volume of exhaust gas in the exhaust lines upstream of the turbine, is reduced, thus improving the response behavior of the turbine. On the other hand, the shortened exhaust lines also lead to lower thermal inertia in the exhaust system upstream of the turbine, resulting in an increase in the temperature of the exhaust gases at the turbine inlet, with the result that the enthalpy of the exhaust gases at the inlet of the turbine is also higher.

Combining the exhaust lines within the cylinder furthermore allows close-packed arrangement of the drive unit. However, a cylinder head designed in this way is subject to higher thermal stresses than a conventional cylinder head fitted with an external manifold and therefore makes greater demands on the cooling system.

Combining the exhaust lines within the cylinder head, i.e. integrating the at least one exhaust manifold, together with the provision of a liquid cooling system for the head advantageously leads to rapid heating of the coolant when the internal combustion engine is cold-started, and hence to more rapid warming up of the internal combustion engine and, where the heating system for the passenger compartment of a vehicle is operated using the coolant, to more rapid heating of said passenger compartment.

A liquid cooling system is found to be advantageous especially for pressure-charged engines since the thermal stress on pressure-charged engines is significantly greater than with conventional internal combustion engines.

From what has been stated above, it follows that embodiments of the cylinder head in which the cylinder head is provided with at least one coolant jacket integrated into the cylinder head to form a liquid cooling system are advantageous.

Embodiments of the cylinder head in which the at least one coolant jacket integrated into the cylinder head is connected to the at least one coolant duct of the turbine are advantageous.

If the at least one coolant jacket integrated into the cylinder head is connected to the at least one coolant duct of the turbine, then in principle there need only be one each of the remaining components and units required to form a cooling circuit since they can be used both for the cooling circuit of the turbine and also for that of the cylinder head, and this leads not only to synergies and considerable cost savings but also to a weight saving. Thus, it is preferable if just one pump is provided to deliver the coolant and one vessel for storing the coolant. The heat released to the coolant in the cylinder head and in the turbine casing, can be removed from the coolant in a common heat exchanger.

In addition, the coolant duct of the turbine can be supplied with coolant via the cylinder head, eliminating any further coolant supply and discharge ports in the turbine casing and also making it possible to dispense with additional coolant lines.

Embodiments in which the cylinder head can be connected at an assembly face to a cylinder block, and the at least one coolant jacket integrated into the cylinder head has a lower coolant jacket, which is arranged between the exhaust lines and the assembly face of the cylinder head, and an upper coolant jacket, which is arranged on the opposite side of the exhaust lines from the lower coolant jacket, with the upper coolant jacket and the lower coolant jacket preferably being connected to one another, are advantageous.

Embodiments of the combination in which the lower coolant jacket and/or the upper coolant jacket are connected to the coolant jacket of the turbine are advantageous.

Embodiments of the combination in which at least one connection is provided between the lower coolant jacket and the upper coolant jacket to allow coolant to pass through, said connection being provided at a distance from the exhaust lines on that side of the integrated exhaust manifold which is remote from the at least two cylinders, are advantageous.

In the present case, the cylinder head has at least one connection, which is arranged in an outer wall of the cylinder head, outside the at least one integrated exhaust manifold.

The connection is an aperture or flow duct which connects the lower coolant jacket to the upper coolant jacket and through which coolant can flow out of the lower coolant jacket into the upper coolant jacket and/or vice versa.

On the one hand, this means that in principle cooling also takes place in the region of the outer wall of the cylinder head. On the other hand, the conventional longitudinal flow of the coolant, or the flow of coolant in the direction of the longitudinal axis of the cylinder head, is supplemented by a transverse flow of coolant, which flows transversely to the longitudinal flow and preferably approximately in the direction of the longitudinal axes of the cylinders. Here, the flow of coolant brought about by the at least one connection makes a decisive contribution to heat dissipation. More particularly, appropriate dimensioning of the cross section of the at least one connection makes it possible to exert a specific effect on the flow velocity of the coolant in the connection and hence on the dissipation of heat in the region of this at least one connection.

Cooling can additionally and advantageously be improved by generating a pressure drop between the upper and the lower coolant jacket, which would in turn increase the velocity in the at least one connection, leading to increased heat transfer as a consequence of convection.

Such a pressure drop also offers advantages if the lower coolant jacket and the upper coolant jacket are connected to the coolant duct of the turbine or to one another via the coolant jacket of the turbine. The pressure drop then serves as a driving force for delivering the coolant through the cooling duct of the turbine.

Embodiments in which the at least one connection is fully integrated into the outer wall of the cylinder head are advantageous. This embodiment is distinct, for example, from cylinder head designs in which the outer wall is provided with a port which is used to supply or discharge coolant to or from the upper and the lower coolant jacket.

Embodiments in which the distance between the at least one connection and the overall exhaust line is less than the diameter, preferably less than half the diameter, of one cylinder, the distance being obtained from the length of travel between the outer wall of the overall exhaust line and the outer wall of the connection, are advantageous.

Embodiments in which at least two connections are provided, each arranged on opposite sides of the overall exhaust line, are advantageous.

Embodiments in which the turbine and the cylinder head are separate components connected to one another nonpositively, positively and/or materially are advantageous.

Modular construction has the advantage that the individual components—namely the turbine and the cylinder head—can also be combined on the modular principle with other components, more particularly other cylinder heads or turbines. The versatility of a component generally increases production numbers, thereby making it possible to reduce unit production costs. Moreover, this reduces costs if the turbine or cylinder head has to be replaced owing to a defect.

Embodiments in which the turbine casing is at least partially integrated into the cylinder head, so that the cylinder head and at least part of the turbine casing form a monolithic component, are also advantageous.

By its very nature, the integral construction eliminates having to form a gas tight connection which is capable of bearing high thermal stresses and is therefore expensive, between the cylinder head and the turbine. As a result, there is also no longer a risk that exhaust gas will accidentally escape into the environment owing to a leak. Similar considerations apply mutatis mutandis in respect of the coolant circuits and the connection of the coolant jackets and in respect of coolant leakage.

The radial turbine employed can be provided with variable turbine geometry, which allows greater adaptation to the respective operating point of an internal combustion engine through adjustment of the turbine geometry and of the effective turbine cross section. In this arrangement, guide vanes are arranged in the inlet zone of the turbine to influence the direction of flow. In contrast to the rotor blades of the revolving rotor, the guide vanes do not rotate with the shaft of the turbine.

If the turbine has a fixed, invariable geometry, the guide vanes are not only stationary but are also furthermore arranged so as to be completely immobile in the inlet zone, i.e. are rigidly fixed. If, on the other hand, a turbine with variable geometry is employed, the guide vanes are indeed arranged so as to be stationary but are not completely immobile, being rotatable about the axis thereof, thus making it possible to vary the incident flow to the rotor blades.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cylinder head having at least one cylinder, comprising:
a radial turbine comprising a rotor arranged in a turbine casing and rotatably mounted on a shaft;
an overall exhaust line which opens into an inlet zone of the radial turbine, said zone merging into a flow duct which carries exhaust gas; and
at least one coolant duct integrated into the turbine casing to form a cooling system, the at least one coolant duct extending in a spiral around the shaft in the casing, the at least one coolant duct extending circumferentially around and at a distance from the flow duct over an angle α, where α≦45°.

2. The cylinder head claimed in claim 1, wherein the radial turbine has a coolant duct integrated into the casing to form a cooling system.

3. The cylinder head as claimed in claim 1, wherein α≦30°.

4. The cylinder head as claimed in claim 1, wherein α≦20°.

5. The cylinder head as claimed in claim 1, wherein α≦15°.

6. The cylinder head as claimed in claim 1, wherein the turbine casing is a casting.

7. The cylinder head as claimed in claim 1, wherein each cylinder has two outlet ports for discharging the exhaust gases from the cylinder.

8. The cylinder head as claimed in claim 1, wherein each cylinder is coupled to at least one exhaust line, and wherein the exhaust lines combine to form at least one overall exhaust line, thereby forming at least one integrated exhaust manifold within the cylinder head.

9. The cylinder head as claimed in claim 1, wherein the cylinder head is provided with at least one coolant jacket integrated into the cylinder head to form a liquid cooling system.

10. The cylinder head as claimed in claim 9, wherein the at least one coolant jacket integrated into the cylinder head is connected to the at least one coolant duct of the radial turbine.

11. The cylinder head as claimed in claim 9, wherein the cylinder head can be connected at an assembly face to a cylinder block, and the at least one coolant jacket integrated into the cylinder head has a lower coolant jacket, which is arranged between the exhaust lines and the assembly face of the cylinder head, and an upper coolant jacket, which is arranged on the opposite side of the exhaust lines from the lower coolant jacket.

12. A system for cooling a turbine, comprising:
a cylinder head including a coolant jacket;
a turbocharger turbine including a rotor rotatably mounted on a shaft and arranged in a turbine casing; and
at least one coolant duct arranged in the turbine casing and coupled to the coolant jacket, the coolant duct extending circumferentially only over an angle α around a flow duct of the turbine, where α≦45°.

13. The system of claim 12, further including an exhaust manifold coupled to the turbine.

14. The system of claim 13, wherein the exhaust manifold is integrated in the cylinder head.

15. The system of claim 12, wherein the turbine casing is comprised of grey cast iron.

16. The system of claim 12, wherein the turbine casing is comprised of cast steel.

17. The system of claim 12, wherein the turbine casing is a casting.

18. A method for cooling a turbine rotatably mounted on a shaft, comprising:
routing coolant through at least one coolant jacket arranged in an exhaust passage side of a cylinder head to a coolant duct of the turbine, the coolant duct of the turbine extending circumferentially around and at a distance from a flow duct of the turbine only over an angle α, where α≦45°.

19. The method of claim 18, wherein routing coolant through the at least one coolant jacket to the coolant duct further comprises routing coolant through the at least one coolant jacket to the coolant duct such that the coolant flows through the coolant duct in a path similar to a path of exhaust gas entering a rotor of the turbine.

20. The method of claim 18, wherein routing coolant through the at least one coolant jacket to the coolant duct further comprises routing coolant through an upper coolant jacket to the coolant duct and routing coolant through a lower coolant jacket to the coolant duct.
